(19) United States
(12) Patent Application Publication
(10) Pub. No.: US 2008/0031735 A1
(43) Pub. Date: Feb. 7, 2008

(54) Single-Shaft Dual-Direction Fan Assembly

(76) Inventor: Yu-Lung Chen, Taoyuan City (TW)

Correspondence Address: WPAT, PC;INTELLECTUAL PROPERTY ATTORNEYS, 2030 MAIN STREET, SUITE 1300, IRVINE, CA, 92614, US

(21) Appl. No.: 11/461,751

(22) Filed: Aug. 1, 2006

(51) Int. Cl. F03D 1/02

(52) U.S. Cl. 416/128

(57) ABSTRACT

A single-shaft dual-direction fan assembly includes a shaft and two fan rotors each mounted on an end of the shaft respectively. The two fan rotors each include a plurality of fan blades, and the fan blades of the two fan rotors are curved toward reverse direction respectively. A motor couples with the shaft to drive the two fan rotors to rotate synchronously so as to generate a dual-directional airflow.

### BACKGROUND OF THE INVENTION

1. Field of the Invention

The present invention relates to a fan assembly, and in particular to a single-shaft dual-direction fan assembly that can synchronously generate a dual-directional airflow.

2. The Prior Arts

A conventional fan generates airflow by means of a motor to drive a fan rotor of the fan to rotate. The fan rotor can only generate a unidirectional airflow. The disadvantage of the conventional fan is that the assembly direction of the fan should be determined according to the requirement of air draft or air exhaust. In addition, the fan cannot generate a dual-directional airflow for drafting and exhausting air synchronously, thereby having lower air convection efficiency.

On the other hand, conventional alternating current (AC) fans, which rotation direction can be controlled by a capacitor in conjunction with a starting coil, can rotate in either direction. The rotation direction of the AC fans can be alternately switched according to the requirement of air draft or air exhaust; therefore there is no need to consider the assembly direction of the AC fans. However, the AC fans are only able to generate a unidirectional airflow at one time. There have still the following disadvantages for the AC fans: (a) when in operation, they can only generate a unidirectional drafting or exhausting airflow, which functions as a fan driven by a unidirectional motor; (b) they can not synchronously generate a dual-direction airflow, and accordingly, can not enhance air convection efficiency; and (c) to obtain a dual-directional airflow for drafting and exhausting air synchronously, it is needed to have two fans installed, which requires more installation time, space, cost, and power consumption. In addition, if the two fans are installed closely, when starting synchronously, they may create mechanical resonance so as to make noises.

### SUMMARY OF THE INVENTION

A primary objective of the present invention is to provide a fan assembly, which can improve the aforementioned disadvantages associated with a conventional fan that cannot generate a dual-directional airflow.

To achieve the above objective, a single-shaft dual-direction fan assembly in accordance with the present invention comprises a shaft and two fan rotors each mounted on an end of the shaft respectively. The two fan rotors each include a plurality of fan blades, and the fan blades of the two fan rotors are curved toward reverse direction respectively. A motor couples with the shaft to drive the two fan rotors to rotate synchronously so as to generate a dual-directional airflow.

Compared with the conventional fans, the single-shaft dual-direction fan assembly in accordance with the present invention can effectively enhance air convection efficiency. It is particularly suitable to be installed in a closed space, such as a computer casing, a central control room, a closed compartment, and an underground construction, for heat-dissipation, ventilation, dehumidification, deodorization, and fungus inhibition.

### BRIEF DESCRIPTION OF THE DRAWINGS

The present invention will be apparent to those skilled in the art by reading the following detailed description of a preferred embodiment thereof, with reference to the attached drawings.

FIG. 1 is a perspective view of a single-shaft dual-direction fan assembly in accordance with a first embodiment of the present invention.

FIG. 2 is a side view of FIG. 1.

FIG. 3 is a schematic view showing that the single-shaft dual-direction fan assembly of FIG. 1 is installed on an opening of a wall body.

FIG. 4 is a perspective view of a single-shaft dual-direction fan assembly in accordance with a second embodiment of the present invention.

FIG. 5 is a perspective view of a single-shaft dual-direction fan assembly in accordance with a third embodiment of the present invention.

### DETAILED DESCRIPTION OF THE PREFERRED EMBODIMENT

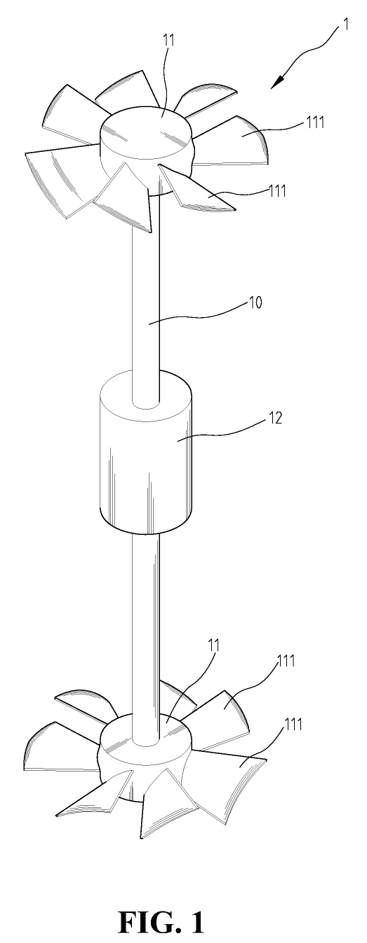

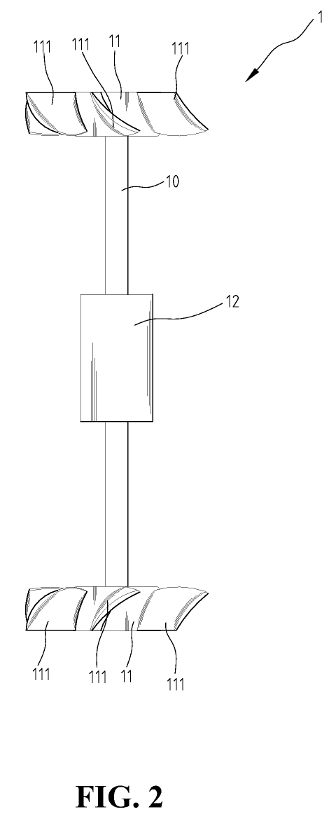

With reference to FIGS. 1 and 2, a single-shaft dual-direction fan assembly 1 in accordance with a first embodiment of the present invention comprises a shaft 10 with two opposite ends and two fan rotors 11 each mounted on the respective end of the shaft 10. The two fan rotors 11 each include a plurality of fan blades 111, and the fan blades 111 of the two fan rotors 11 are curved toward reverse direction respectively. A motor 12 couples with the shaft 10 to drive the fan rotors 11 to rotate synchronously. The shaft 10 is a spindle of the motor 12.

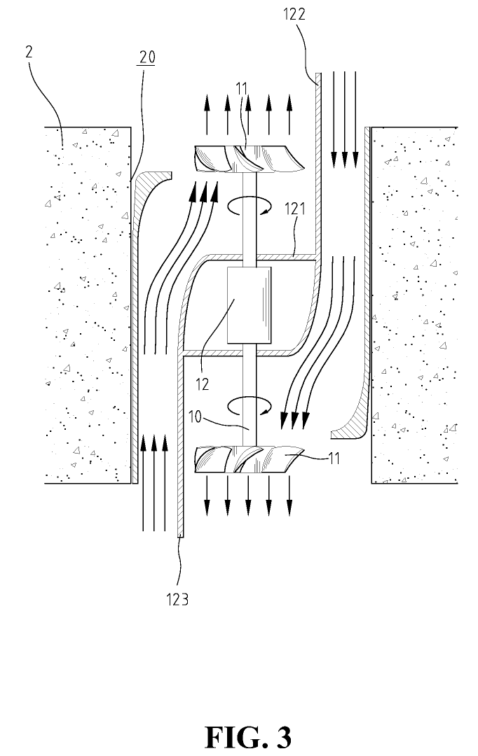

Please refer to FIG. 3, which shows the single-shaft dual-direction fan assembly of FIG. 1 installed on an opening 20 of a wall body 2. A housing 121 encloses the motor 12 of the single-shaft dual-direction fan 1, and has an upper baffle 122 and a lower baffle 123 respectively extending from the housing 121 toward reverse directions. With the blockage of the housing 121, the upper baffle 122 and the lower baffle 123, the opening 20 of the wall body 2 is separated into two independent ventilating channels.

When the motor 12 drives the shaft 10 together with the two fan rotors 11 to rotate synchronously, the reversely curved fan blades 111 of the two fan rotors 11 generate two opposite airflows respectively passing through the two independent ventilating channels so as to enhance air convection efficiency between inner and outer spaces defined by the wall body 2.

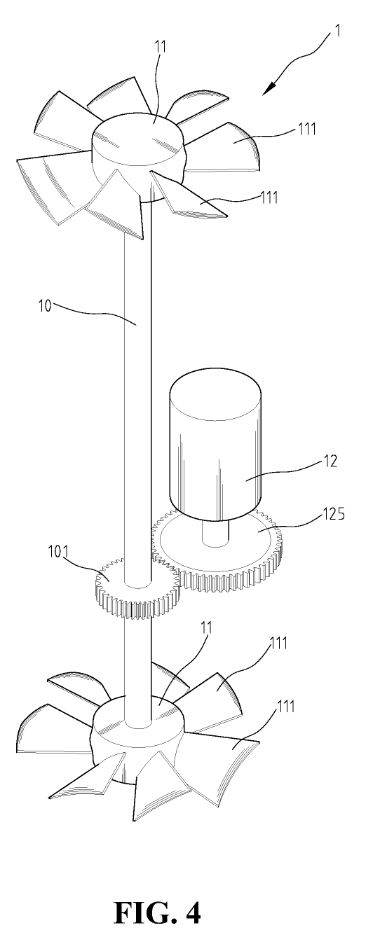

Please refer to FIG. 4, which shows a single-shaft dual-direction fan assembly 1 in accordance with a second embodiment of the present invention. The motor 12 connects with a driver gear 125 that engages with a follower gear 101 mounted on the shaft 10. When the motor 12 rotates, the driver gear 125 drives the follower gear 101 together with the shaft 10 to rotate, and the two fan rotors 11 synchronously rotate with the shaft 10 so as to generate a dual-directional airflow.

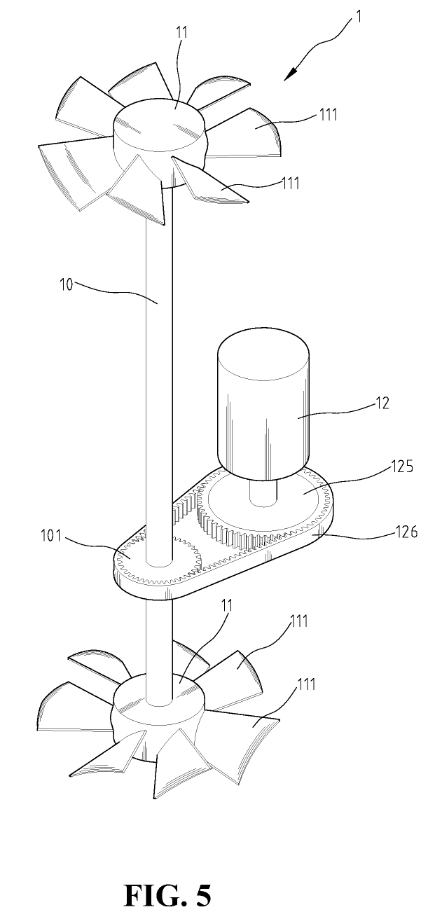

Please refer to FIG. 5, which shows a single-shaft dual-direction fan assembly 1 in accordance with a third embodiment of the present invention. The motor 12 connects with the driver gear 125, the follower gear 101 is mounted on the shaft 10, and a chain 126 connects the driver gear 125 with the follower gear 101. When the motor 12 rotates, the driver gear 125 drives the chain 126 to drive the follower gear 101 together with the shaft 10 to rotate synchronously, and the two fan rotors 11 synchronously rotate with the shaft 10 so as to generate a dual-directional airflow.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A single-shaft dual-direction fan assembly, comprising:
a shaft having two opposite ends;
two fan rotors each mounted on the respective end of the shaft, wherein the two fan rotors each include a plurality of fan blades, and the fan blades of the two fan rotors are curved toward reverse direction respectively; and
a motor coupled with the shaft, whereby when the motor rotates, the shaft and the two fan rotors are driven to rotate synchronously so as to generate a dual-directional airflow.

2. The single-shaft dual-direction fan assembly as claimed in claim 1, wherein the shaft is a spindle of the motor.

3. The single-shaft dual-direction fan assembly as claimed in claim 1, wherein said motor connects with a driver gear that engages with a follower gear mounted on the shaft.

4. The single-shaft dual-direction fan assembly as claimed in claim 1, wherein the motor connects with a driver gear, a follower gear is mounted on the shaft, and a chain connects the driver gear with the follower gear.
